(19) United States
(12) Patent Application Publication
(10) Pub. No.: US 2019/0031140 A1
(43) Pub. Date: Jan. 31, 2019

(54) SECURE LOCKING HUB SYSTEM

(71) Applicant: Adam Price, Springfield, OH (US)

(72) Inventor: Adam Price, Springfield, OH (US)

(21) Appl. No.: 15/663,450

(22) Filed: Jul. 28, 2017

(51) Int. Cl. B60R 25/09; B60B 27/02; F16D 1/10; B60B 27/06; B62D 63/08

(52) U.S. Cl. CPC B60R 25/09; B60B 27/02; F16D 2001/103; B60B 27/065; B62D 63/08; F16D 1/10

(57) ABSTRACT

A secure locking hub system for locking a wheel hub of a trailer to a fixed axle of the trailer is provided. The system has a locking ring that may be moved between a locked and unlocked configuration. When locked, the hub is in a rotationally fixed position relative to the axle on which the hub is mounted. With the hub locked to a fixed axle, the trailer cannot be moved when locked. The system additionally has a security lock that secures the locking ring in place in order to prevent any unauthorized individual from unlocking the hub and stealing the trailer.

### FIELD OF THE INVENTION

The present invention relates generally to a secure locking hub system that may be installed on a trailer to prevent theft of the trailer.

### BACKGROUND

Trailers pulled by powered vehicles may be used to transport a variety of goods or materials, such as cargo, tools, equipment, vehicles, or livestock. Thus, many types of trailers have been designed for different purposes. These may include enclosed cargo trailers, flatbed trailers, boat trailers, vehicle trailers, livestock trailers, or dollies. Other types of trailers may be adapted to provide shelter, such as construction trailers or travel trailers. Trailers are typically attached to a powered vehicle using a hitch, which is used to tow the trailer behind the vehicle from location to location. The trailer may be detached from the vehicle by removing the trailer from the hitch.

Because trailers have monetary value and in addition are often used to haul and/or store valuable items, trailers are often a target of theft. Hitch coupler locks are commonly used to prevent theft of trailers by securely latching a coupler onto a ball on the trailer hitch and locking the coupler into place. A coupler lock system locks a trailer to a vehicle hitch when the trailer is hitched to a vehicle and may also prevent a trailer from being hitched to a vehicle when the trailer is not currently hitched. However, hitch coupler lock systems generally use an exposed lock, such as a padlock, which may be cut by lock cutters or otherwise compromised in order to facilitate removing a hitched trailer from a vehicle and/or allowing an unhitched trailer to be hitched to a vehicle for the purpose of stealing the trailer. In addition, if the coupler or the latching mechanism of a coupler lock system fails, the locking system may be rendered inoperable.

Accordingly, a need exists in the art for an improved system for preventing theft of trailers.

### SUMMARY

In one aspect, a secure locking hub system for locking a wheel hub of a trailer to a fixed axle is provided. The system locks a wheel hub in a rotationally fixed position relative to the fixed axle and has security features designed to prevent unauthorized unlocking of the hub. The system is installed on a trailer axle to prevent rotation of a wheel when the trailer is not in use in order to prevent theft of the trailer. Preferably, multiple locking hub systems may be installed on a trailer for locking each individual wheel hub.

The system includes a hub that may be mounted on an axle with a wheel attached to the hub. The system is designed such that it may be switched between a locked configuration and an unlocked configuration. When in the locked configuration, the hub and attached wheel will not rotate on the axle. With the wheel hub locked to the fixed trailer axle, the trailer cannot be moved by towing the trailer because the wheel will not rotate. When in the unlocked configuration, the hub and attached wheel may freely rotate so that the trailer may be towed by a vehicle. The system further comprises a security lock that secures the locking hub system in the locked configuration in order to prevent any unauthorized individual from switching the system into the unlocked configuration. Thus, the security lock prevents unauthorized movement of the trailer and thus prevents theft.

In a preferred embodiment, the locking hub system comprises a hub rotatably coupled to and positioned around a fixed axle, a locking ring that moves back and forth in an axial direction into locked and unlocked configurations, and a keyed lock configured to selectively limit movement of the locking ring between the locked and unlocked configurations. The locking ring has an exterior splined surface configured to mate with an interior splined surface of the hub. In addition, the locking ring has an interior splined surface configured to mate with an axle exterior splined surface in the locked configuration and to decouple from the axle exterior splined surface in the unlocked configuration. In a preferred embodiment, the keyed security lock is secured to a cap fastened to the hub with tamper-proof fasteners to prevent unauthorized disassembly of the locking hub system done to circumvent the security lock. To lock and unlock the hub from the axle, a user may insert a key into a keyhole in the lock and rotate the key to move the locking ring between the locked and unlocked configurations. In one embodiment, the lock comprises a lever that rotates in response to input from the key. The lever is attached to a rotating cam configured to move the locking ring in an inward axial direction into the locked configuration and in an outward axial direction into the unlocked configuration. Thus, an unauthorized user not in possession of the key will not be able to unlock the hub and will thus be unable to move the trailer.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### DESCRIPTION OF THE DRAWINGS

These and other features, aspects, and advantages of the present invention will become better understood with regard to the following description, appended claims, and accompanying drawings where:

FIG. 1 shows a perspective view of a trailer including a locking hub system for locking and unlocking a wheel hub to an axle in accordance with the present disclosure.

FIG. 2 shows an exploded view of a locking hub system in accordance with the present disclosure.

FIG. 3 shows an exploded view of a locking hub system in accordance with the present disclosure.

FIG. 4 shows an exploded view of components of a locking hub system including a bearing in accordance with the present disclosure.

FIG. 4A shows a perspective view of a component of a locking hub system in accordance with the present disclosure.

FIG. 5 shows an exploded view of a cap assembly for a locking hub system in accordance with the present disclosure.

FIG. 6 shows an exploded view of a cap assembly for a locking hub system in accordance with the present disclosure.

FIG. 7 shows a side elevational view of a cap assembly for a locking hub system in a locked configuration in accordance with the present disclosure.

FIG. 8 shows a side elevational view of a cap assembly for a locking hub system in an unlocked configuration in accordance with the present disclosure.

FIG. 9 shows a perspective view of a hub of a locking hub system with a splined axle ring configured to attach to an axle in accordance with the present disclosure.

FIG. 10 shows a front elevational view of a locking hub system with a wheel attached thereto in accordance with the present disclosure.

FIG. 11 shows a perspective view of an example key that may be used to secure a locking hub system in accordance with the present disclosure.

FIG. 12 shows a side elevational view of a locking hub system in an assembled state in accordance with the present disclosure.

FIG. 13 shows a cross sectional view of the assembled locking hub system shown in FIGS. 10 and 12 in accordance with the present disclosure.

FIG. 14 shows a perspective view of an example lock that may be used to switch a locking hub system between locked and unlocked configurations in accordance with the present disclosure.

FIG. 15 shows a perspective view of an example tamper proof bolt that may be used to fasten the cap assembly shown in FIGS. 5 and 6 to a hub in accordance with the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

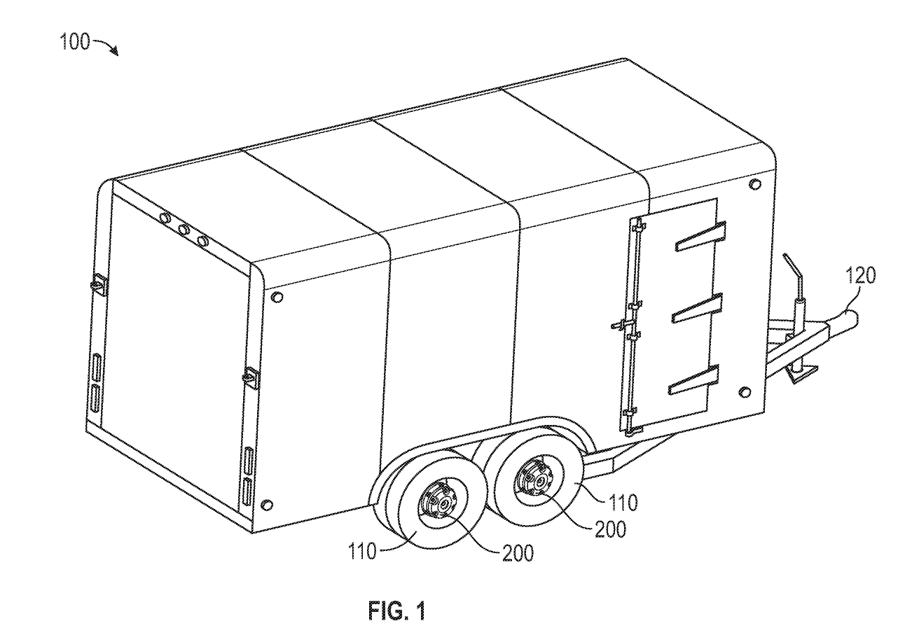

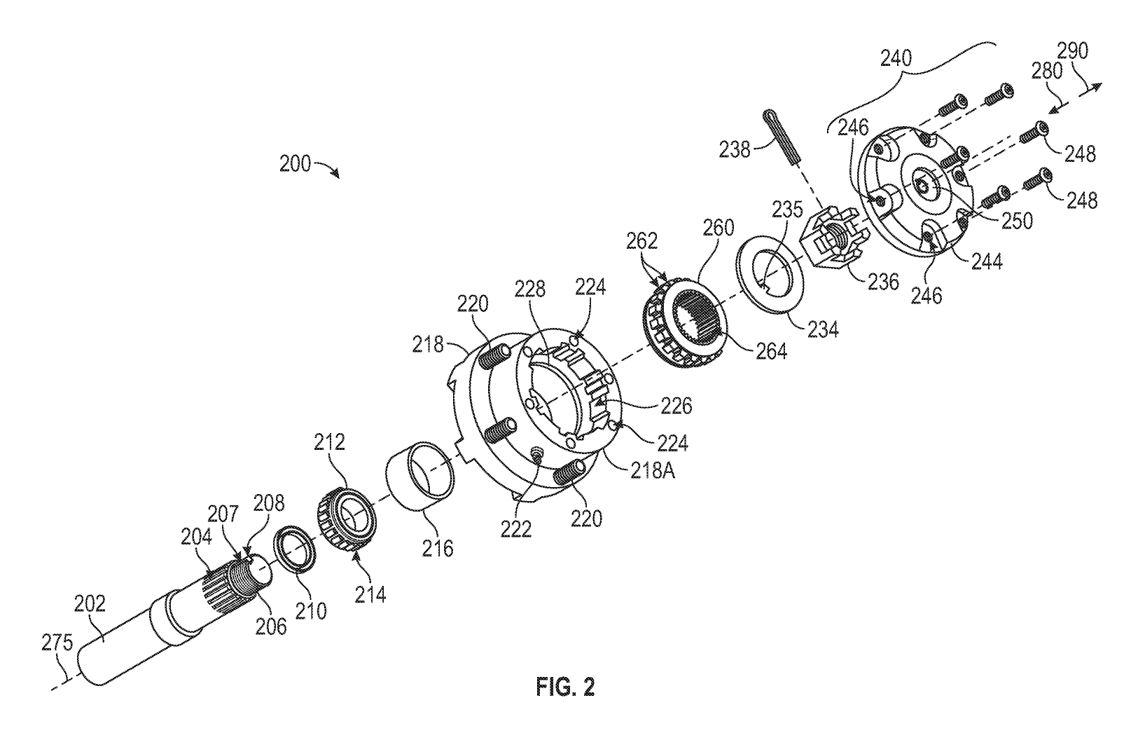

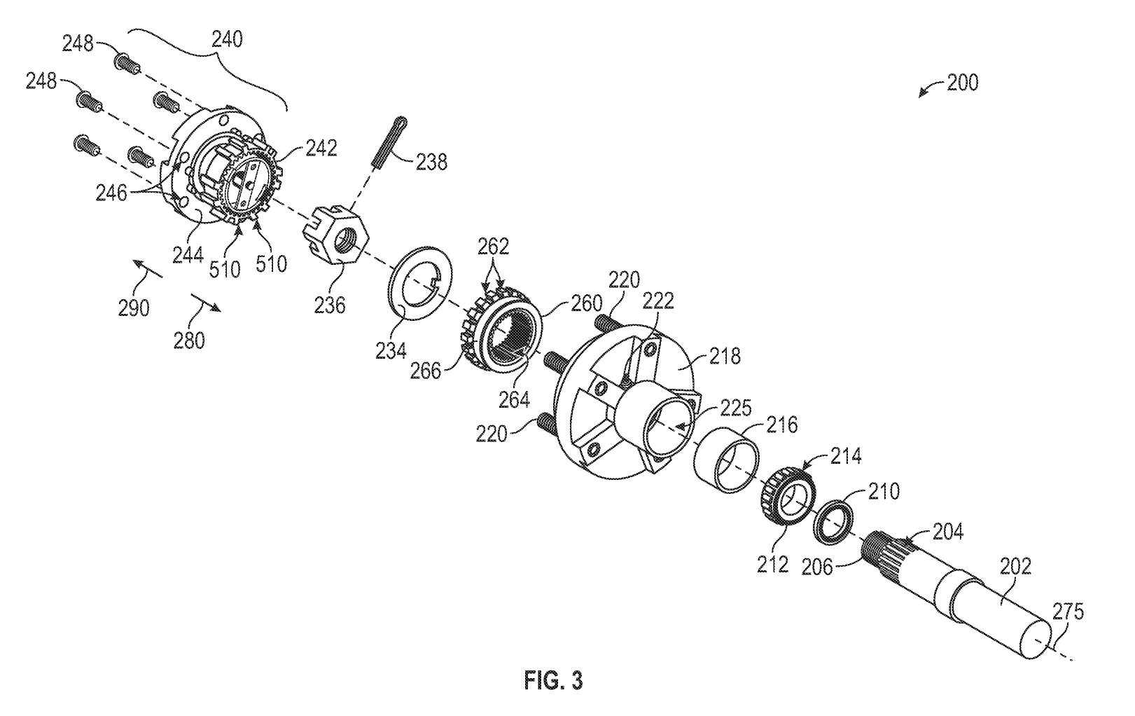

FIG. 1 shows a trailer 100 having two wheels 110 on each side with each wheel having a locking hub system 200 installed for locking the wheel. Each wheel 110 is attached to a hub 218 that is rotatably coupled to and positioned around a fixed axle 202, of which an end portion can be seen in FIGS. 2 and 3. The trailer 100 has a coupler 120 for hitching the trailer to a trailer hitch ball attached to a motorized vehicle. Because the trailer 100 is not motorized but is instead towed by a motorized vehicle for transport, the axle 202 does not rotate and remains in a fixed position. The hub 218 and the wheel 110 attached thereto are mounted on the axle 202 and supported by bearings. The trailer 100 shown in FIG. 1 may have an axle spanning the width of the trailer between opposing wheels and supporting two opposing wheels, or may have individual axles for each individual wheel 110 to attach to.

The locking hub system 200 is designed to allow the hub 218 to rotate freely on the axle 202 when in an unlocked configuration and to prevent the hub 218 from rotating when in a locked configuration. Thus, the trailer 100 cannot be moved when the locking hub system 200 is in the locked configuration because the wheels 110 will not rotate, thereby preventing theft of the trailer 100. The locking hub system 200 has a security lock 250 that prevents any unauthorized individual from unlocking the hub 218 once the system is in the locked configuration. A key 600 configured to operate the lock 250 may be used to switch between the locked and unlocked configurations.

FIGS. 2 and 3 show an exploded view of an illustrative locking hub system 200 that may be used to lock the wheel 110 of the trailer 100 shown in FIG. 1 in a rotationally fixed position. The locking hub system 200 comprises a hub 218 rotatably coupled to and positioned around a fixed axle 202. The hub 218 rotates about a central axis 275, which is common to all components, including the fixed axle 202, when the trailer 100 is being towed by a motorized vehicle and the wheels 110 are thus rotating. As used herein, an inward direction refers to a direction extending toward the fixed axle 202, and an outward direction refers to a direction extending away from the axle 202 toward a cap 244 having an exterior surface accessible from the exterior of the wheel 110, as shown in FIG. 10. Arrow 280 indicates an inward direction, and arrow 290 indicates an outward direction. FIGS. 2 and 3 illustrate various components of the system 200 to show how those components fit together and may not be to scale.

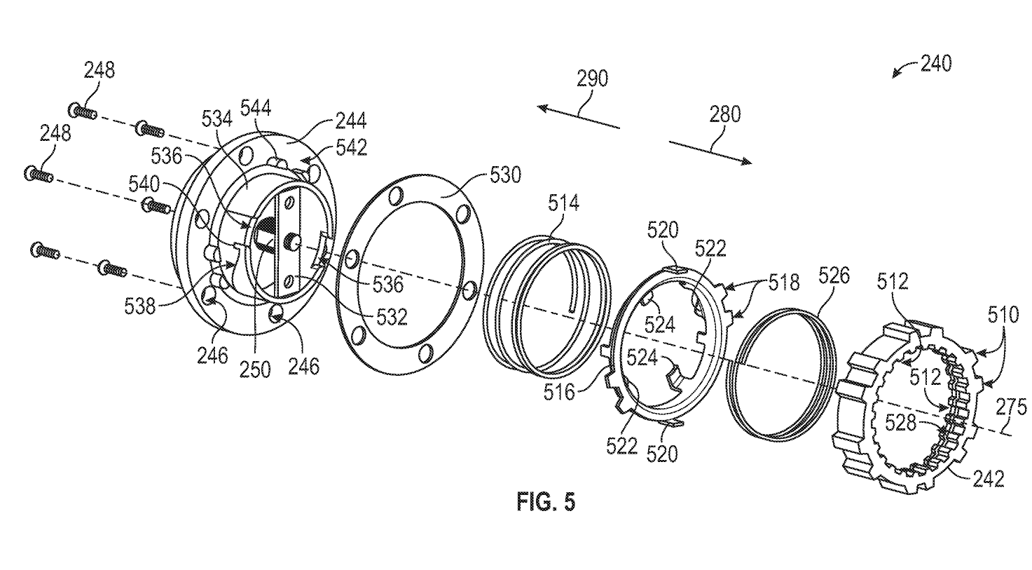

As shown in FIGS. 2 and 3, the locking hub system 200 further comprises a locking ring 242 having a locking ring exterior splined surface 510 configured to mate with an interior splined surface 226 of the hub 218. Thus, the locking ring 242 can move inward and outward in an axial direction but will not rotate within the hub 218. The locking ring 242 also has a locking ring interior splined surface 512, as shown in FIG. 5, configured to mate with an axle exterior splined surface 262 in a locked configuration and to decouple from the axle exterior splined surface 262 in an unlocked configuration. Thus, to switch the system 200 from an unlocked configuration into a locked configuration, the locking ring 242 is moved inward in an axial direction such that the interior splined surface 512 of the locking ring 242 is mated with the axle exterior splined surface 262 while the exterior splined surface 510 is simultaneously mated with the hub interior splined surface 226. Because the axle 202 (and thus the axle exterior splined surface 262) are always in a fixed position (i.e., they do not rotate) the hub 218 also will not rotate when the locking ring 242 is actuated into the locked configuration, thereby locking the hub 218 in place and preventing the wheel 110 from rotating. To switch the system 200 from a locked configuration into an unlocked configuration, the locking ring 242 is moved outward in an axial direction such that the interior splined surface 512 of the locking ring 242 decouples from the axle exterior splined surface 262. When the locking ring 242 is decoupled in this manner, the hub 218 may rotate freely when the trailer 100 is towed. When the locking ring 242 moves inward and outward between the locked and unlocked configurations, the exterior splined surface 510 remains mated with the hub interior splined surface 226 such that the locking ring 242 will not rotate relative to the hub 218.

In a preferred embodiment, as shown in FIGS. 2 and 3, the system 200 further comprises an axle ring 260. The axle exterior splined surface 262 is preferably disposed on the exterior of the axle ring 260, which is removably secured directly to and positioned around the fixed axle 202 in a rotationally fixed position. Thus, when the axle ring 260 is secured to the axle 202, the axle ring 260 will not rotate. To secure the axle ring 260 directly to the axle 202, the axle ring 260 preferably has an axle interior splined surface 264 configured to mate with a set of splines 204 disposed directly on the axle 202. Thus, the axle ring 260 may be installed on the axle 202 by sliding the axle ring 260 in an axial direction onto the axle 202. However, it should be understood that the axle ring 260 may be secured to the axle 202 in any manner suitable to secure the axle ring 260 in a rotationally fixed position.

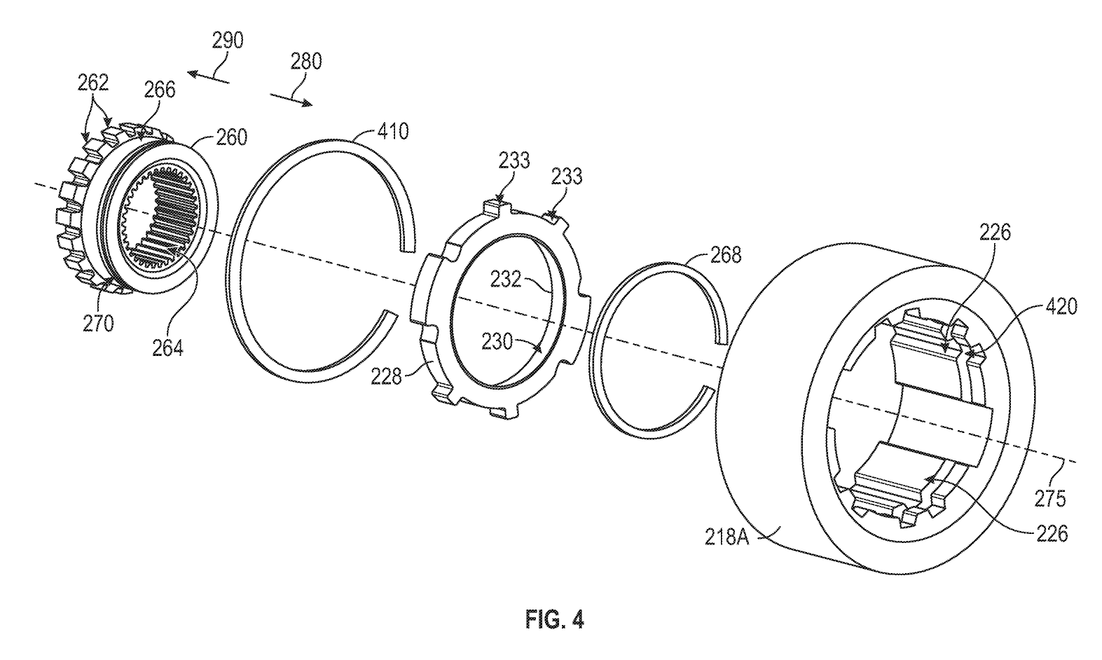

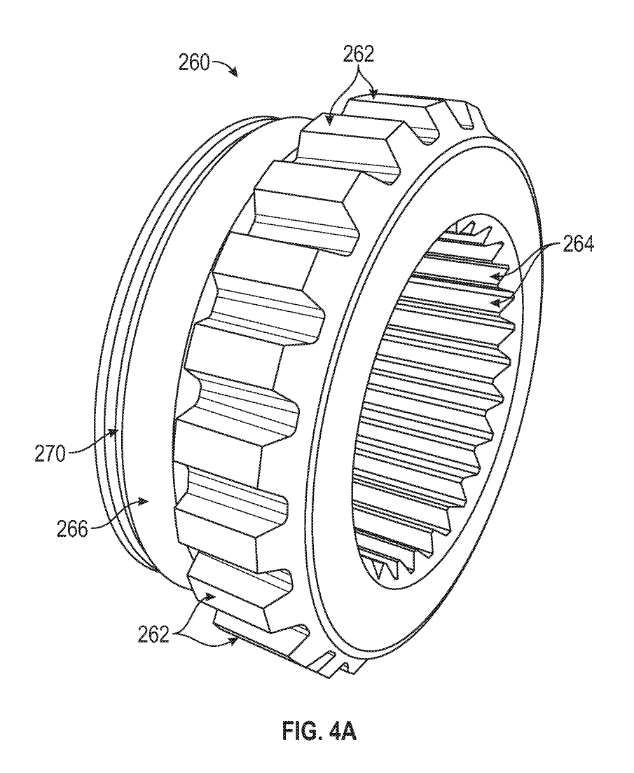

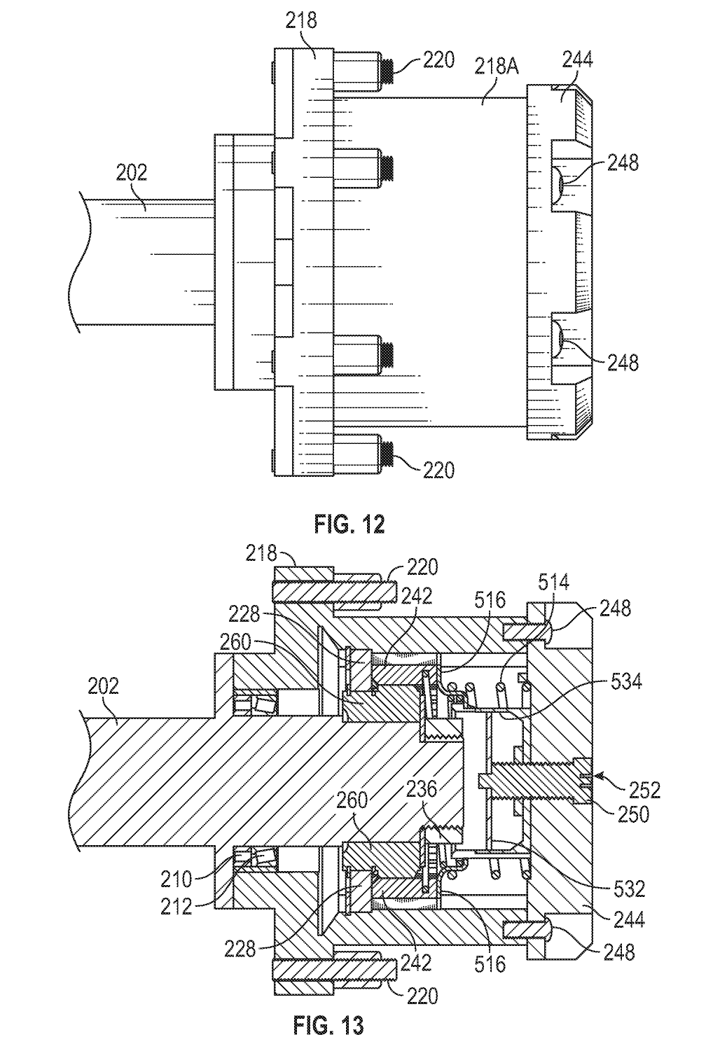

As best seen in FIGS. 4 and 4A, the axle ring 260 additionally has an external cylindrical surface 266 positioned axially inward relative to the axle exterior splined surface 262. The hub 218 comprises a bearing 228 that has an inner bearing surface 230 that is positioned around and in face sharing contact with the external cylindrical surface 266 of the axle ring 260. The hub 218 and attached bearing 228 rotate about the axle 202 on the cylindrical surface 266 of the axle ring 260. FIG. 4 shows an exploded view illustrating the axle ring 260, the bearing 228, and a portion 218A of the hub 218. FIGS. 2 and 12 illustrate the hub portion 218A shown in FIG. 4 as a component of the hub 218. For ease of illustrating the hub interior splined surface 226, FIG. 4 shows part 218A detached from the hub 218. However, the hub 218 is preferably made of a single piece of material as shown in FIG. 2.

The bearing 228 supports the hub 218 as the hub 218 rotates around the axle 202 when the trailer 100 is in motion. As shown in FIG. 4, the bearing 228 is preferably a plain bearing but alternatively may be a roller bearing comprising a set of rollers contacting the external cylindrical surface 266 of the axle ring 260. The bearing 228 preferably has exterior splines 233 configured to mate with the interior splined surface 226 of the hub 218A and may be installed within the hub 218A by inserting the bearing 228 in an inward direction 280 into the hub 218A. The bearing 228 may be held in place with a retaining ring 410, which is preferably a C-shaped clip, inserted into a circular groove 420 around an interior circumference of the hub 218A. To hold the bearing 228 in place and prevent outward movement of the bearing 228, the retaining ring 410 is positioned on the outward facing side of the bearing 228. To prevent inward movement of the bearing 228, the hub 218A may have a lip around an interior circumference of the hub 218A on the inward facing side of the bearing 228. FIG. 2 illustrates the bearing 228 installed within the hub 218. The bearing 228 may be removed for maintenance or replacement by removing the retaining ring 410. Alternatively, the bearing 228 and the hub 218 may be formed from a unitary piece of material such that the bearing 228 cannot be removed.

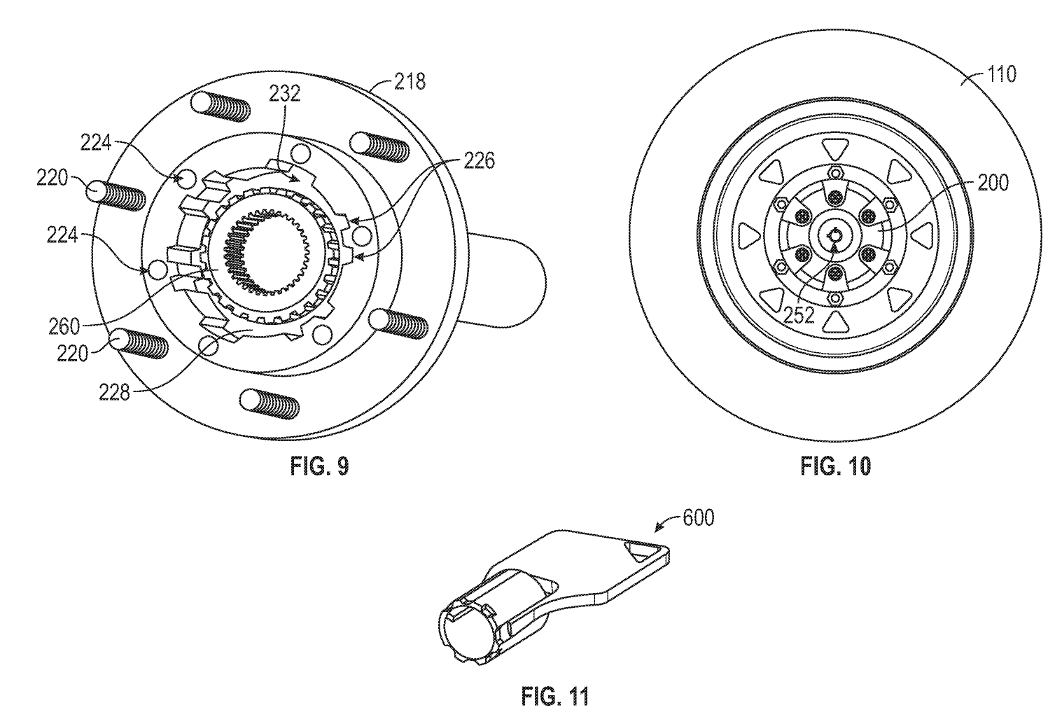

The axle ring 260 may be installed within the bearing 228 by inserting the inward facing end of the axle ring 260 into the bearing 228 such that the external cylindrical surface 266 is positioned within and in face sharing contact with the inner bearing surface 230. Once installed, to prevent outward movement of the axle ring 260, a retaining ring 268 may be installed within a circular groove 270 positioned toward the inward end of the external cylindrical surface 266 such that the retaining ring 268 is positioned on the inward side of the bearing 228. Preferably, the axle ring 260 is installed within the bearing 228 before installing the bearing 228 within the hub 218. FIG. 9 illustrates the bearing 228 and axle ring 260 installed in the hub 218 before mounting the hub 218 on the axle 202. The hub 218 may then be mounted on the axle 202 by inserting the axle 202 through a central opening 225 in the hub and into the axle ring 260.

In an alternative embodiment, the locking ring 242 may be configured such that the locking ring interior splined surface 512 mates directly with the splines 204 disposed directly on the axle 202 when in the locked configuration. Thus, in this embodiment, the splines 204 located on the axle 202 itself may function as the axle exterior splined surface 262, and the bearing 228 may be sized to contact a cylindrical surface directly on the axle 202. However, for ease of maintenance, the system 200 preferably includes an axle ring 260.

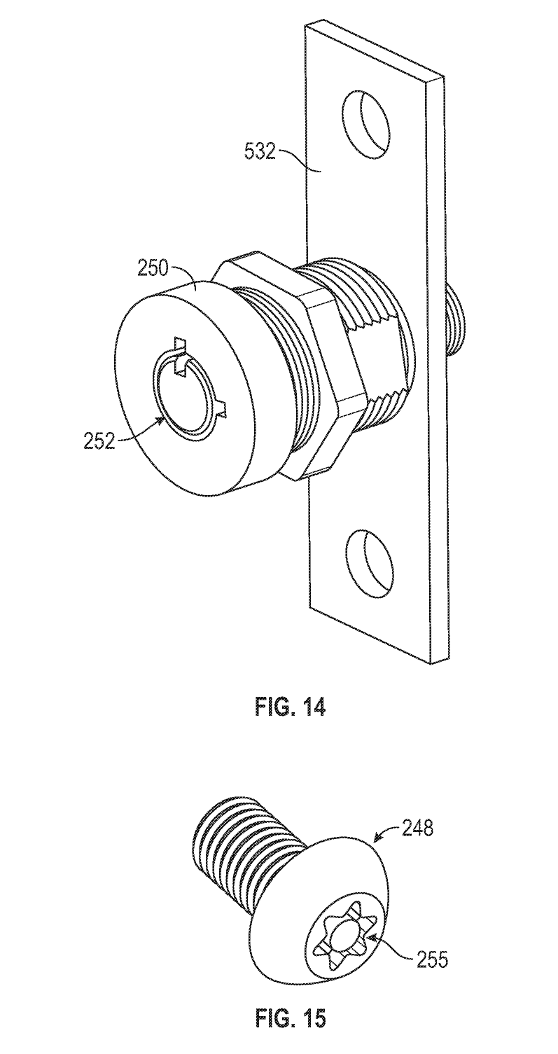

The locking hub system 200 further comprises a lock 250 configured to selectively limit movement of the locking ring 242 between the locked and unlocked configurations. FIG. 14 illustrates an example lock 250 that may be installed in the locking hub system 200. In a preferred embodiment, the lock 250 is a tubular cam lock having a rotating lever 532 attached thereto. However, any suitable locking device may be utilized. FIG. 11 illustrates an example key 600 configured to operate the lock 250. Each locking hub system 200 (or each set of systems installed on multiple wheel hubs of the same trailer) requires a unique key 600 to operate the lock 250.

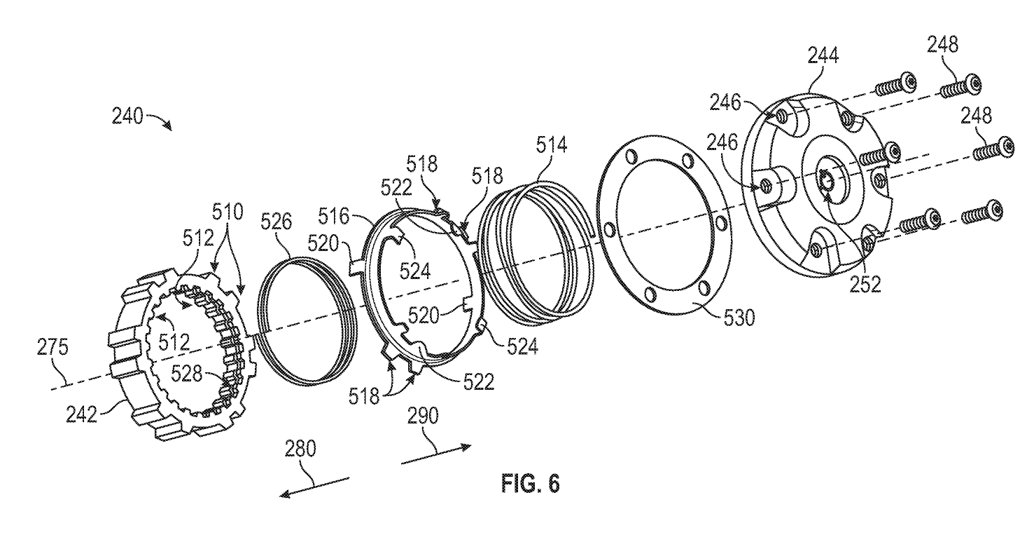

As shown in FIGS. 2 and 3, in a preferred embodiment, the system 200 comprises a cap assembly 240 that provides an exterior cover for the system with an externally accessible keyhole 252 for operating the lock 250. FIGS. 5 and 6 show exploded views of the cap assembly 240. The cap assembly 240 comprises a cap 244 that provides the exterior cover. The cap 244 is fastened to the hub 218 by bolts 248 inserted through openings 246 in the cap 244 and threaded into holes 224 in the hub 218. A gasket 530 is preferably used to seal the connection. The bolts 248 are preferably tamper-proof bolts in order to prevent unauthorized disassembly of the system 200 done for the purpose of bypassing the lock 250. FIG. 15 illustrates one example of a tamper-proof bolt 248 that may be used. The head of each bolt 248 has a non-standard engagement surface 255. Thus, the bolts 248 cannot be removed using standard commercially available tools such as a standard wrench, a socket wrench, a screwdriver, or a hex key. A specially adapted tool may be provided with the system 200 for engaging the bolt 248 heads for authorized assembly and disassembly of the system 200.

The lock 250 is secured to the cap 244 such that only an external face of the lock 250 with the keyhole 252 therein is accessible. As shown in FIG. 14, the lock 250 may have external threads that may be threaded into a threaded opening in the cap 244 during manufacturing (before attaching lever 532 thereto). In a preferred embodiment, both the cap 244 and the lock 250 are constructed of metal, and a portion of the lock 250 may be welded or otherwise permanently attached to the cap 244. Thus, the lock 250 cannot be tampered with or otherwise compromised.

The lock 250 is configured to move the locking ring 242 in an axial direction into the locked configuration and into the unlocked configuration in response to input from the key 600. To actuate the locking ring 242, the lock 250 comprises a lever 532 that rotates in response to input from the key 600. As shown in FIG. 5, the lever 532 is fixedly attached to a rotating cam 534 that rotates with the lever 532. The cam 534 is configured to move the locking ring 242 in an axial direction into the locked and unlocked configurations. The cam 534 is rotatably secured to the cap 244 so that the cam 534 may rotate within the stationary cap 244 when the cap 244 is fastened to the hub 218. The locking ring 242 is operably connected to the cam 534 by a circular clip 516 and a retaining coil 526. The clip 516 clips onto one side of the locking ring 242, and the retaining coil 526 secures the clip and locking ring together. The clip 516 preferably has spline extensions 518 that are superposed over exterior splines 510 of the locking ring 242 to provide support for the clip and to ensure that the clip 516 is properly aligned on the locking ring 242. In addition, the clip 516 preferably has clipping extensions 520 that clip onto the exterior surface of the locking ring 242 between exterior splines 510 to hold the clip in place on the locking ring 242. The retaining coil 526 fits partially within a lateral groove 528 in the interior splined surface 512 and partially over retaining extensions 522 on the clip 516 in order to secure the clip 516 to the locking ring 242.

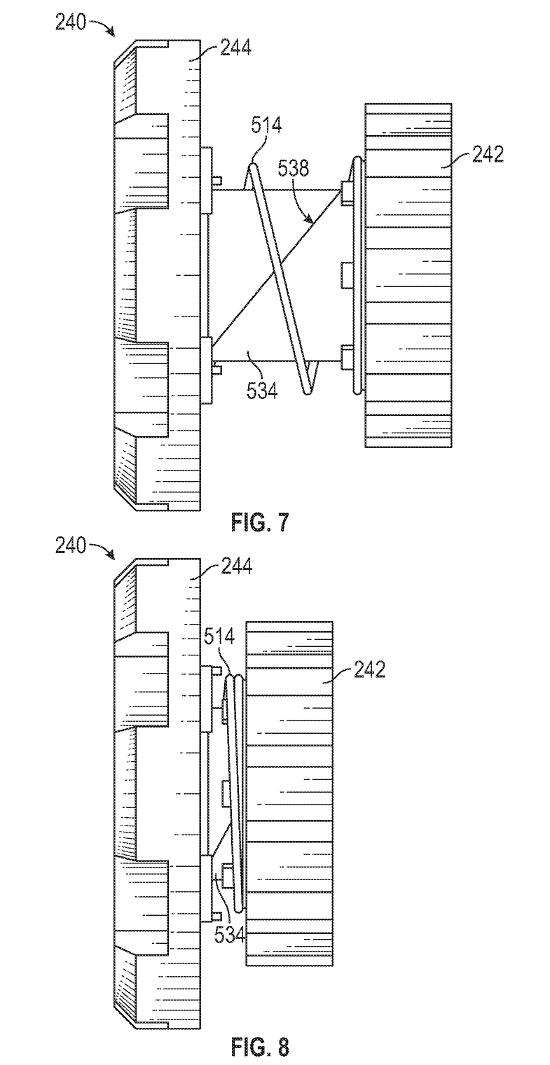

The locking ring 242 is biased in an inward direction (i.e., away from the cap 244) by a compression spring 514. The compression spring 514 is sized at one end to fit firmly around the clip 516 that is secured to the locking ring 242. The opposing end of the spring 514 fits against an inward facing surface 542 of the cap 244, preferably within guides 544 molded into the cap 244. With the clip 516 secured to the locking ring 242, the locking ring 242 may be operably connected to the cam 534 by inserting two opposing guides 524 on the clip 516, which are angled toward the center of the circular clip 516, through two opposing recesses 536 on the cam 534 against the force of the spring 514 and then rotating the locking ring 242 and the clip 516 attached thereto in a counterclockwise direction before releasing the locking ring 242. The cam 534 has two raised, ramped surfaces 538 extending circumferentially around opposing sides of the cam with a stopping protrusion 540 on each side of the cam to prevent the guides 524 from disengaging from the cam 534. The ramped surfaces 538 interact with the guides 524 to translate rotational movement of the cam due to input from the key 600 rotating the lever 532 into axial movement of the locking ring 242. The force of the spring 514 pushes the locking ring 242 in an inward direction so that the guides 524 of the clip 516 remain engaged with the raised, ramped surfaces 538. Thus, from the perspective shown in FIG. 5, when the cam 534 rotates in a clockwise direction, the guides 524 are forced to move along the ramped surfaces 538 in an outward direction 290 (due to the mating of the locking ring 242 with the hub interior splines 226). Thus, the locking ring 242 is pulled in an outward direction (i.e., toward the cam 534 and the cap 244) against the force of the spring 514, which decouples the locking ring 242 from the axle exterior splined surface 262 and thus moves the locking ring 242 into the unlocked configuration. FIG. 8 shows the cap assembly 240 fully assembled and in the unlocked configuration. Conversely, when the cam 534 rotates in a counterclockwise direction, the guides 524 are forced to move along the ramped surfaces 538 in an inward direction, and the force of the spring 514 pushes the locking ring 242 and attached clip 516 in an inward direction (i.e., away from the cam 534 and the cap 244) into the locked configuration in which the interior splined surface 512 mates with the axle exterior splined surface 262. FIG. 7 shows the cap assembly 240 fully assembled and in the locked configuration. The locking ring 242 does not rotate with the cam 534 during axial movement because the locking ring is guided by the interior splined surface 226 of the hub 218 mated to the exterior splined surface 510 of the locking ring 242.

Thus, a user may insert the key 600 into the keyhole 252 and rotate the key 600 in one direction for the locked configuration, thereby causing the locking ring 242 to move in an inward axial direction to mate with the axle exterior splined surface 262, and in the opposite direction for the unlocked configuration, thereby causing the locking ring 242 to move in an outward axial direction to decouple from the axle exterior splined surface 262.

The locking ring exterior splined surface 510 and the hub interior splined surface 226 may have splines that are not equidistantly spaced, which may help to ensure that components of the system are properly aligned during assembly. However, the locking ring interior splined surface 512 and the axle exterior splined surface 262 preferably have equidistantly spaced splines to facilitate smooth coupling of these splined surfaces when switching the system into the locked configuration. In addition, as shown in FIG. 4A, the splines of the axle exterior splined surface 262 are preferably tapered on the outward side of the axle ring 260 to further facilitate smooth coupling of the locking ring interior splines 512 with the axle exterior splines 262.

Returning to FIGS. 2 and 3, to install the locking hub system 200, a seal 210 may first be installed around a fixed axle 202, which is attached to a trailer 100, to prevent grease from leaking out and water from getting into the hub 218. An inner bearing 212 having a series of rollers 214 may then be installed around the axle 202, and a race 216 may be installed within the hub 218 to provide a surface on which the hub 218 may rotate around the inner bearing 212. The bearing 228 shown in FIG. 4, which functions as an outer bearing in conjunction with the inner bearing 212, may then be installed in the hub 218. The axle ring 260 is preferably installed within the bearing 228 with an optional retaining ring 268 prior to installing the bearing 228 in the hub (if the retaining ring 268 is not used, the axle ring 260 may be installed after installation of the bearing 228). The hub 218 may then be fitted around the axle 202 through the central opening 225 of the hub. The axle ring 260 is installed such that the axle interior splined surface 264 is mated with the splines 204 disposed directly on the axle 202 and the external cylindrical surface 266 is fitted inside the bearing 228 and in face sharing contact with the inner bearing surface 230. A washer 234 and nut 236 are then threaded onto a threaded section 206 of the axle 202, and a cotter pin 238 may be inserted through an opening 208 at the end of the axle 202. The washer 234 may have an inner extension 235 that fits into a groove 207 in the threaded section 206 of the axle 202. The ends of the cotter pin 238 are bent so as to not interfere with the axial movement of the locking ring 242. An assembled cap assembly 240 is then installed by sliding the locking ring 242 into the hub 218 so that the exterior splined surface 510 of the locking ring 242 is mated to the interior splined surface 226 of the hub 218 and bolting the cap 244 to the hub 218 using tamper-proof bolts 248. Grease fittings 222 are preferably installed on the hub 218 and positioned so that all bearings can be greased.

FIG. 9 shows the hub 218 with the bearing 228 installed therein and the axle ring 260 installed within the bearing 228 opening, but before attachment to the axle 202. As shown in FIG. 9, there is an annular space between the exterior of the axle ring 260 and the interior splined surface 226 of the hub 218. The locking ring 242 fits into this annular space when in the locked configuration to prevent the hub 218 from rotating about the axle ring 260 on the bearing 228. The bearing 228 has an outward facing surface 232, which may contact an inward facing surface of the locking ring 242 and prevent further inward movement of the locking ring 242 when moving from the unlocked to the locked configuration.

FIG. 10 shows a wheel 110 mounted on an assembled locking hub system 200 by fastening the wheel 110 to bolts 220 extending in an outward direction from the hub 218. The keyhole 252 is visible on the exterior surface of the cap 244 and is thus accessible from exterior of the trailer 100 for the purpose of locking and unlocking the hub 218, as needed for security. FIG. 12 illustrates a side view of an assembled locking hub system 200 mounted on an axle 202 of a trailer 100.

FIG. 13 illustrates a cross-sectional view of the assembled locking hub system 200 mounted on an axle 202 of a trailer 100 as shown in FIG. 10. The system shown in FIG. 13 is in the locked configuration. The axle 202 and attached axle ring 260 always remain in a rotationally fixed position. The locking ring 242 is engaged with the axle ring 260, which indicates that the system 200 is in the locked configuration. If the lever 532 and cam 534 rotate in response to input from the key 600 engaging the lock 250, the clip 516 will be forced to move in an outward direction, which will compress the spring 514 and decouple the locking ring 242 from the axle ring 260, thereby switching the system to the unlocked configuration. When decoupled from the axle ring 260, the hub 218 may freely rotate on bearings 228 and 212.

It will be appreciated that the configurations and methods shown and described herein are illustrative only, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein. It is understood that versions of the invention may come in different forms and embodiments. Additionally, it is understood that one of skill in the art would appreciate these various forms and embodiments as falling within the scope of the invention as disclosed herein.

What is claimed is:

1.) A locking hub system comprising:
a hub rotatably coupled to and positioned around a fixed axle, wherein the hub has a hub interior splined surface;
an axle exterior splined surface positioned around a circumference of the fixed axle;
a locking ring having a locking ring exterior splined surface configured to mate with the hub interior splined surface, wherein the locking ring has a locking ring interior splined surface configured to mate with the axle exterior splined surface in a locked configuration and to decouple from the axle exterior splined surface in an unlocked configuration; and
a lock configured to selectively limit movement of the locking ring between the locked and unlocked configurations.

2.) The locking hub system of claim 1, wherein the lock is configured to move the locking ring in an axial direction into the locked configuration and into the unlocked configuration in response to input from a key configured to operate the lock.

3.) The locking hub system of claim 2, wherein the lock is secured to a cap that is fastened to the hub with tamper-proof fasteners.

4.) The locking hub system of claim 3, wherein the lock comprises a lever that rotates in response to input from the key, wherein the lever is fixedly attached to a rotating cam configured to move the locking ring in an axial direction into the locked configuration and into the unlocked configuration.

5.) The locking hub system of claim 4, wherein the locking ring is biased in an inward axial direction by a compression spring disposed between the cap and the locking ring.

6.) The locking hub system of claim 2, wherein the lock comprises a lever that rotates in response to input from the key, wherein the lever is fixedly attached to a rotating cam configured to move the locking ring in an axial direction into the locked configuration and into the unlocked configuration.

7.) The locking hub system of claim 1, wherein the axle exterior splined surface is disposed on an axle ring removably secured directly to and positioned around the fixed axle in a rotationally fixed position, and wherein the hub comprises a bearing positioned around and in contact with an external cylindrical surface of the axle ring.

8.) The locking hub system of claim 1, wherein the hub will not rotate when the locking ring is in the locked configuration, and wherein the hub will freely rotate when the locking ring is in the unlocked configuration.

9.) A locking hub system comprising:
a hub positioned around a fixed axle and rotatably coupled to the fixed axle via a bearing, wherein the hub has a hub interior splined surface;
an axle ring removably secured directly to and positioned around the fixed axle in a rotationally fixed position, wherein the axle ring has an axle exterior splined surface positioned around a circumference of the fixed axle, wherein the bearing is positioned around and in contact with an external cylindrical surface of the axle ring; and
a cap assembly comprising a keyed lock secured to a cap, wherein the lock comprises a lever that rotates in response to input from a key configured to operate the lock, wherein the lever is fixedly attached to a rotating cam configured to move a locking ring in an axial direction into a locked configuration and into an unlocked configuration, wherein the locking ring has a locking ring exterior splined surface configured to mate with the hub interior splined surface, and wherein the locking ring has a locking ring interior splined surface configured to mate with the axle exterior splined surface in the locked configuration and to decouple from the axle exterior splined surface in the unlocked configuration.

10.) The locking hub system of claim 9, wherein the hub will not rotate when the locking ring is in the locked configuration, and wherein the hub will freely rotate when the locking ring is in the unlocked configuration.

11.) The locking hub system of claim 9, wherein the cap assembly is fastened to the hub with tamper-proof fasteners.

12.) The locking hub system of claim 9, wherein the locking ring is biased in an inward axial direction by a compression spring disposed between the cap and the locking ring.

13.) A trailer having opposing wheels, wherein at least one wheel is mounted on a locking hub system comprising:
a hub rotatably coupled to and positioned around a fixed axle, wherein the hub has a hub interior splined surface;
an axle exterior splined surface positioned around a circumference of the fixed axle;
a locking ring having a locking ring exterior splined surface configured to mate with the hub interior splined surface, wherein the locking ring has a locking ring interior splined surface configured to mate with the axle exterior splined surface in a locked configuration and to decouple from the axle exterior splined surface in an unlocked configuration; and
a keyed lock configured to selectively limit movement of the locking ring between the locked and unlocked configurations.

14.) The trailer of claim 13, wherein the lock is configured to move the locking ring in an axial direction into the locked configuration and into the unlocked configuration in response to input from a key configured to operate the lock.

15.) The trailer of claim 14, wherein the lock is secured to a cap that is fastened to the hub with tamper-proof fasteners.

16.) The trailer of claim 15, wherein the lock comprises a lever that rotates in response to input from the key, wherein the lever is fixedly attached to a rotating cam configured to move the locking ring in an axial direction into the locked configuration and into the unlocked configuration.

17.) The trailer of claim 16, wherein the locking ring is biased in an inward axial direction by a compression spring disposed between the cap and the locking ring.

18.) The trailer of claim 14, wherein the lock comprises a lever that rotates in response to input from the key, wherein the lever is fixedly attached to a rotating cam configured to move the locking ring in an axial direction into the locked configuration and into the unlocked configuration.

19.) The trailer of claim 13, wherein the axle exterior splined surface is disposed on an axle ring secured directly to and positioned around the fixed axle, and wherein the hub comprises a bearing positioned around and in contact with an external cylindrical surface of the axle ring.

20.) The trailer of claim 13, wherein the hub will not rotate when the locking ring is in the locked configuration, and wherein the hub will freely rotate when the locking ring is in the unlocked configuration.
